(19) United States
(12) Patent Application Publication
(10) Pub. No.: US 2019/0116794 A1
(43) Pub. Date: Apr. 25, 2019

(54) Antimicrobial powder

(71) Applicant: Halt Pathogen Control Solutions, LLC, Olathe, KS (US)

(72) Inventors: Julia Hayward Smith, Leawood, KS (US); Khaled Mahran Rashwan, Overland Park, KS (US); Gregory G. Bertsch, Sioux Falls, SD (US)

(21) Appl. No.: 15/999,204

(22) Filed: Aug. 17, 2018

Related U.S. Application Data
(60) Provisional application No. 62/546,913, filed on Aug. 17, 2017.

(51) Int. Cl. A01N 43/66; A01N 25/10; A01N 25/12; B65G 15/30

(52) U.S. Cl. CPC A01N 43/66; A01N 25/10; B82Y 30/00; B65G 15/30; A01N 25/12

(57) ABSTRACT

An antimicrobial powder comprising metal oxide nanoparticles; an organosilane coupling agent immobilized on the nanoparticles; and triazine-based N-halamine compounds having functional groups covalently bonded to the organosilane coupling agent. A method of making the antimicrobial powder is also provided.

### STATEMENT REGARDING FEDERALLY SPONSORED RESEARCH OR DEVELOPMENT

Some embodiments of the invention disclosed herein were made with government support under Grant No. 2015-33610-23597 entitled “A POTENT, RENEWABLE, AND DURABLE FIELD ADMINISTRABLE ANTIMICROBIAL TREATMENT FOR MODULAR CONVEYOR BELTS” awarded by the National Institute of Food and Agriculture (NIFA) to Antimicrobial Materials, Inc. The U.S. Government has certain rights in this invention.

### TECHNICAL FIELD

Embodiments of the present disclosure generally relate to antimicrobial powders. In particular, the present disclosure provides antimicrobial powders including N-halamine containing nanoparticles, which may be suitable in some embodiments as additives to polymeric materials.

### BACKGROUND

Microorganisms or microbes are microscopic organisms including, for example, bacteria, archaea and most protozoa. While 95% of all microbes are not harmful to humans, contamination by the remaining 5% poses one of the most costly and dangerous global challenges. About one third of industry sectors that contribute to the entire US gross domestic product are susceptible to losses attributable to undesired microbial growth.

### Industry Sectors Include:

Health Care: It is estimated that there are approximately 1.7 million cases of nosocomial infection in the US that cause or contribute to 99,000 deaths per year.

Food Processing: About 1 in 6 Americans gets sick each year from foodborne pathogens.

Agriculture: Approximately 10% of all US dairy production is lost due to mastitis caused by bacterial infection.

Manufacturing, Energy, & Transportation: Surface biofouling and biocorrosion costs billions of dollars each year in energy losses caused by increased flow resistance, decreased heat exchanger performance, and corrosion damage.

Biocidal materials offer promise in helping to curb the spread of harmful microbes by providing contamination-resistant surfaces for applications such as biomedical devices, food processing and packaging products, and other molded articles.

N-halamines as direct additives to materials are prone to stability problems as they tend to leach from, for example, polymer matrices over time. A need exists for a stable powder capable of providing antimicrobial activity to commonly used materials or articles.

### SUMMARY

While multiple embodiments are disclosed, still other embodiments of the present invention will become apparent to those skilled in the art from the following detailed description, which shows and describes illustrative embodiments of the invention.

Embodiments of the present disclosure include an antimicrobial powder comprising: metal oxide nanoparticles; an organosilane coupling agent immobilized on the nanoparticles; and triazine-based N-halamine compounds having functional groups covalently bonded to the organosilane coupling agent.

The antimicrobial powder according to paragraph [0011], wherein the metal oxide nanoparticles are hydrophilic.

The antimicrobial powder according to either paragraph [0011] or [0012], wherein the metal oxide nanoparticles have a specific surface area of from about 30 m²/g to about 1,000 m²/g.

The antimicrobial powder according to any of paragraphs [0011]-[0013], wherein the metal oxide nanoparticles have a specific surface area of about 200 m²/g.

The antimicrobial powder according to any of paragraphs [0011]-[0014], wherein the metal oxide nanoparticles are at least one material chosen from silica (SiO2) nanoparticles, titanium dioxide (TiO₂) nanoparticles, alumina (Al₂O₃) nanoparticles, chromium oxide (Cr₂O₃) nanoparticles, and mixtures thereof.

The antimicrobial powder according to any of paragraphs [0011]-[0015], wherein the metal oxide nanoparticles are silica nanoparticles.

The antimicrobial powder according to any of paragraphs [0011]-[0016], wherein the metal oxide nanoparticles are hydrophilic fumed silica nanoparticles.

The antimicrobial powder according to any of paragraphs [0011]-[0017], wherein the metal oxide nanoparticles have an equivalent spherical diameter from about 5 nm to about 1,000 nm.

The antimicrobial powder according to any of paragraphs [0011]-[0018], wherein the organosilane coupling agent is at least one member chosen from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, (3-Glycidoxypropyl)methyldiethoxysilane, and mixtures thereof.

The antimicrobial powder according to any of paragraphs [0011]-[0019], wherein the organosilane coupling agent is (3-Glycidyloxypropyl)trimethoxysilane (GOPTS).

The antimicrobial powder according to any of paragraphs [0011]-[0020], wherein the triazine-based N-halamine compounds include triazine of the formula (I):

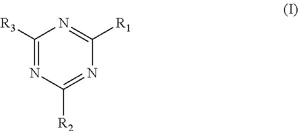

where R₁ is halogen, nitrogen, nitrogen halide, or organic group, R₂ is halogen, nitrogen, nitrogen halide or organic group, and R₃ is halogen, nitrogen, nitrogen halide or organic group, wherein halogen is chosen from chlorine (Cl), bromine (Br), iodine (I), and mixtures thereof; and wherein organic group is chosen from carboxylates, hydroxyls, epoxides, and mixtures thereof.

The antimicrobial powder according to any of paragraphs [0011]-[0021], wherein the triazine-based N-halamine compounds include the replacement of one or more hydrogens with at least one member chosen from Cl, Br, and I.

Embodiments of the present disclosure also include a method of preparing an antimicrobial powder, the method comprising: providing metal oxide nanoparticles; immobilizing the metal oxide nanoparticles with an organosilane to form organosilane functionalized metal oxide nanoparticles; dispersing the organosilane functionalized metal oxide silica nanoparticles in an aqueous triazine compound solution to form triazine-conjugated metal oxide nanoparticles, wherein the aqueous triazine compound solution includes triazine of the formula (I) (shown above) where R₁ is halogen, nitrogen, nitrogen halide or organic group, R₂ is halogen, nitrogen, or nitrogen halide organic group, and R₃ is halogen, nitrogen, nitrogen halide or organic group, wherein halogen is chosen from chlorine (Cl), bromine (Br), iodine (I), and mixtures thereof; and wherein organic group is chosen from carboxylates, hydroxyls, epoxides, and mixtures thereof; and, dispersing the triazine-conjugated metal oxide nanoparticles in an aqueous halogen solution to form halogenated N-halamine nanoparticles.

The method according to paragraph [0023], wherein the metal oxide nanoparticles are hydrophilic.

The method according to either paragraph [0023] or [0024], wherein the metal oxide nanoparticles have a specific surface area of from about 30 m²/g to about 1,000 m²/g.

The method according to any of paragraphs [0023]-[0025], wherein the metal oxide nanoparticles have a specific surface area of about 200 m²/g.

The method according to any of paragraphs [0023]-[0026], wherein the metal oxide nanoparticles are at least one material chosen from silica (SiO₂) nanoparticles, titanium dioxide (TiO₂) nanoparticles, alumina (Al₂O₃) nanoparticles, or chromium oxide (Cr₂O₃) nanoparticles, and mixtures thereof.

The method according to any of paragraphs [0023]-[0027], wherein the metal oxide nanoparticles are silica nanoparticles.

The method according to any of paragraphs [0023]-[0028], wherein the metal oxide nanoparticles are hydrophilic fumed silica nanoparticles.

The method according to any of paragraphs [0023]-[0029], wherein the metal oxide nanoparticles have an equivalent spherical diameter of from about 5 nm to about 1,000 nm.

The method according to any of paragraphs [0023]-[0030], wherein the organosilane coupling agent is at least one member chosen from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, (3-Glycidoxypropyl)methyldiethoxysilane, and mixtures thereof.

The method according to any of paragraphs [0023]-[0031], wherein the organosilane coupling agent is (3-Glycidyloxypropyl)trimethoxysilane (GOPTS).

The method according to any of paragraphs [0023]-[0032], wherein immobilizing the metal oxide nanoparticles includes dispersing the metal oxide nanoparticles in ethanol followed by the addition of GOPTS to form GOPTS functionalized metal oxide nanoparticles.

The method according to any of paragraphs [0023]-[0033], wherein the aqueous melamine solution has a pH of 8.

The method according to any of paragraphs [0023]-[0034], wherein the aqueous halogen solution is hypochlorite.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 a schematic view illustrating a reaction procedure according to an embodiment of the present disclosure.

FIG. 2 a flow chart illustrating a method for making an antimicrobial powder according to an embodiment of the present disclosure.

FIG. 3 illustration of particle size distribution of the nanoparticles before and after immobilization according to an embodiment of the present disclosure.

FIG. 4 scanning electron micrographs illustration of the particle morphology before and after functionalization according to an embodiment of the present disclosure;

FIG. 5 is an image of conveyor belt sections made with a polymeric material including the antimicrobial powder of the present invention.

Accordingly, the drawings and detailed description are to be regarded as illustrative in nature and not restrictive.

### DETAILED DESCRIPTION

The present disclosure provides antimicrobial materials, specifically powders, useful to provide long-lasting, renewable and broad-spectrum biocidal activity. These powders can be integrated into or otherwise used with various compositions, materials and coatings to provide the compositions, materials and coatings with long-lasting, renewable and broad-spectrum biocidal activity. Antimicrobial powders according to the present disclosure include halogen-bearing compounds such as N-halamines. The halogen ions are consumed as microbes are contacted, but the antimicrobial properties are advantageously renewable or replenishable by additional halogenation.

An N-halamine is a compound containing one or more nitrogen-halogen covalent bonds. These bonds are formed by the halogenation (such as, for example, chlorination or bromination) of an imide, amide, or amine group. One property of N-halamines is that when microbes come into contact with the N—X structures, where X is chlorine (Cl), bromine (Br), or iodine (I), a halogen exchange reaction occurs, resulting in the expiration of the microorganisms. Without being bound by theory, the antimicrobial action of N-halamines is believed to be a manifestation of a chemical reaction involving the transfer of positive halogens from the N-halamines to appropriate receptors in the microbial cells. This process can effectively destroy or inhibit the enzymatic or metabolic cell processes, resulting in the expiration of the organisms.

The antimicrobial material is formed of nanoparticles of metal oxides, the nanoparticles being used as a carrier for N-halamine moieties. In some embodiments, the antimicrobial powder comprises metal oxide nanoparticles, an organosilane coupling agent immobilized on the nanoparticles, and triazine-based N-halamine compounds having functional groups covalently bonded to the organosilane coupling agent.

In some embodiments, the metal oxide nanoparticles are hydrophilic. That is, the nanoparticles include active hydroxyl groups at the surface. In some embodiments, active OH sites can be created by disrupting the metal-oxygen (M-O) bonds using methods such as plasma. In other embodiments, active OH sites may exist without processing.

In some embodiments, suitable metal oxide nanoparticles have a specific surface area of from about 30 m²/g to about 1,000 m²/g. In some embodiments the metal oxide nanoparticles may have a specific surface area of from 30 m²/g to 1,000 m²/g, in other embodiments from 50 m²/g to 500 m²/g, in other embodiments from 10 m²/g to 300 m²/g, and in yet other embodiments from 150 m²/g g to 250 m²/g. In one example, the metal oxide nanoparticles have a specific surface area of about 200 m²/g. Specific surface area is measured by Brunauer-Emmett-Teller (BET) method or other methods as known in the art. In at least one embodiment of the present disclosure, the metal oxide nanoparticles are silica nanoparticles, such as but not limited to hydrophilic fumed silica nanoparticles. In one example, the metal oxide nanoparticles are fumed silica composed of spheres. The specific surface area is generally correlated to the sphere diameter. In general, the smaller the particle diameter, the larger the specific surface area.

In some embodiments, the metal oxide nanoparticles have an equivalent spherical diameter of from about 5 nm to about 1,000 nm. For example, in some embodiments, the metal oxide nanoparticles have an equivalent spherical diameter from 5 nm to 1,000 nm, in other embodiments from 5 nm to 500 nm, in other embodiments from 10 nm to 300 nm, and in yet other embodiments from 10 nm to 200 nm. Nanoparticles can be manufactured with tailored sizing by using various methods including pyrogenic processes or chemical synthesis techniques.

Metal oxide nanoparticles useful in the present disclosure include, but are not limited to, at least one material chosen from silica (SiO₂) nanoparticles, titanium dioxide (TiO₂) nanoparticles, alumina (Al₂O₃) nanoparticles, chromium oxide (Cr₂O₃) nanoparticles, and mixtures thereof. In some embodiments, the metal oxide nanoparticles are limited to one member selected from silica (SiO₂) nanoparticles, titanium dioxide (TiO₂) nanoparticles, alumina (Al₂O₃) nanoparticles, and chromium oxide (Cr₂O₃) nanoparticles. In some embodiments, the metal oxide nanoparticles are high purity, for example having a purity of at least 99%. In other embodiments, the metal oxide nanoparticles are at least 99.9% pure. In some embodiments, the silica nanoparticles are at least 99% SiO2, and in other embodiments at least 99.9% SiO₂. In some embodiments, the titanium dioxide nanoparticles are at least 99% TiO₂, and in other embodiments at least 99.9% TiO₂. In some embodiments, the alumina nanoparticles are at least 99% Al₂O₃, and in other embodiments at least 99.9% Al2O3. In some embodiments, the chromium oxide nanoparticles are at least 99% Cr₂O₃, and in other embodiments at least 99.9% Cr₂O₃.

In at least some embodiments of the present disclosure, the metal oxide nanoparticles are functionalized or otherwise associated with an intermediate (i.e. organosilane) that serves as a covalent coupling agent between the nanoparticles and the N-halamine moieties. In some embodiments the coupling agent is an organosilane coupling agent. Examples of organosilanes include Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, and (3-Glycidoxypropyl)methyldiethoxysilane. In some embodiments, the organosilane coupling agent is at least one member chosen from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, (3-Glycidoxypropyl)methyldiethoxysilane, and mixtures thereof. In other embodiments, the metal oxide nanoparticles are limited to one member selected from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, and (3-Glycidoxypropyl)methyldiethoxysilane. In some embodiments, the organosilane coupling agent may be an epoxy functional silane such as (3-Glycidyloxypropyl)trimethoxysilane (GOPTS). GOPTS is also referred to, interchangeably herein, as C9H20O5Si, 3-(2,3-Epoxypropoxy)propyltrimethoxysilane, GLYMO, and Glycidyl 3-(trimethoxysilyl)propyl ether.

Suitable N-halamine structures include triazine compounds, for example as shown in (I):

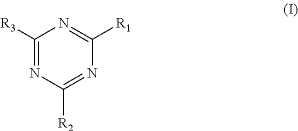

where R₁ is halogen, nitrogen, nitrogen halide, or organic group; R₂ is halogen, nitrogen, nitrogen halide, or organic group; and R₃ is halogen, nitrogen, nitrogen halide, or organic group. Suitable halogen groups for R₁, R₂, and/or R₃ include but are not limited to the following: chlorine (Cl), bromine (Br), and iodine (I). Suitable organic groups for R₁, R₂, and/or R₃ include but are not limited to the following: carboxylates, hydroxyls, and epoxides. In some embodiments, the triazine compound is melamine. Triazine functional groups react with complementary functional groups on the coupling agent to produce a covalently bonded structure.

In at least some embodiments of the present disclosure, the triazine-based N-halamine compounds include the replacement of one or more hydrogens with at least one member chosen from chlorine (Cl), bromine (Br), iodine (I), and mixtures thereof. Structures possess antimicrobial properties as the N—H structures are converted into N-halamines by the replacement of one or more hydrogens with at least one member chosen from Cl, Br, I, and mixtures thereof. The reaction formula of chlorination is shown in (II):

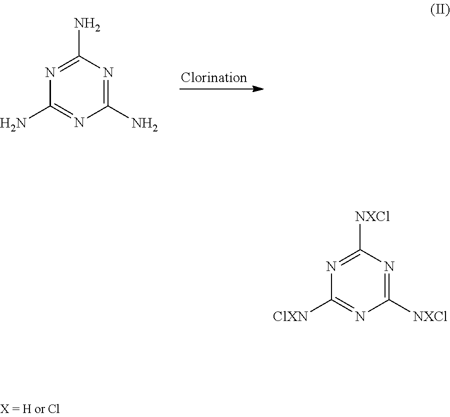

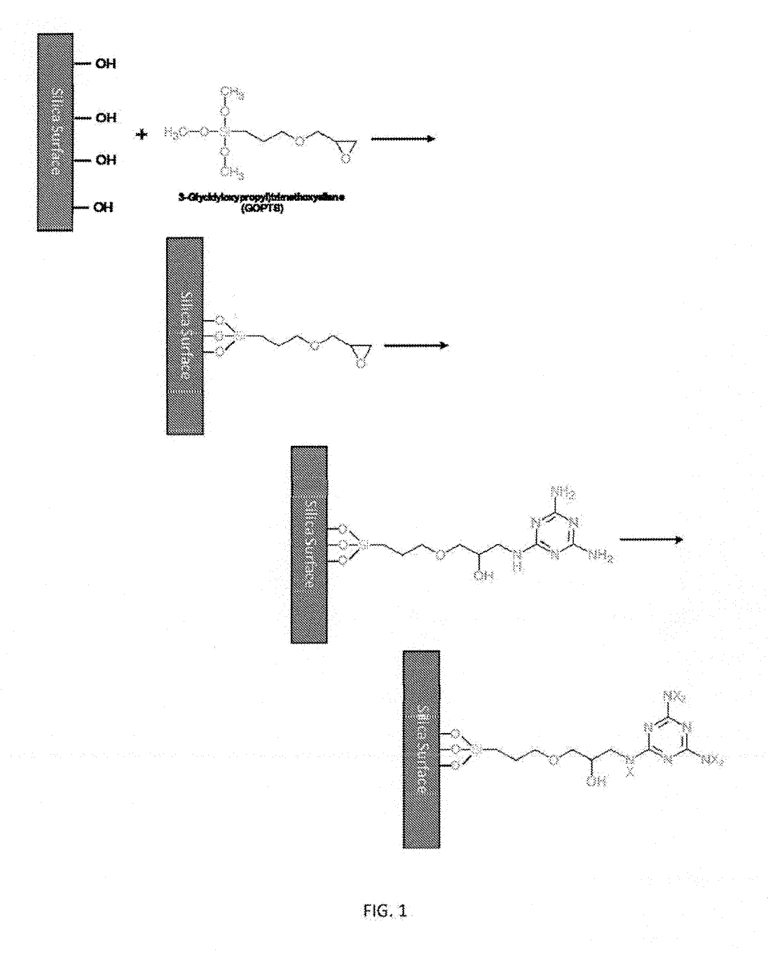

The coupling agent improves the density of N-halamine immobilization on the nanoparticle and in some embodiments, final active chlorine levels of 0.2% to 5% by weight of the functionalized nanoparticles can be achieved. The reaction procedure for an example using silica nanoparticles is schematically illustrated in FIG. 1.

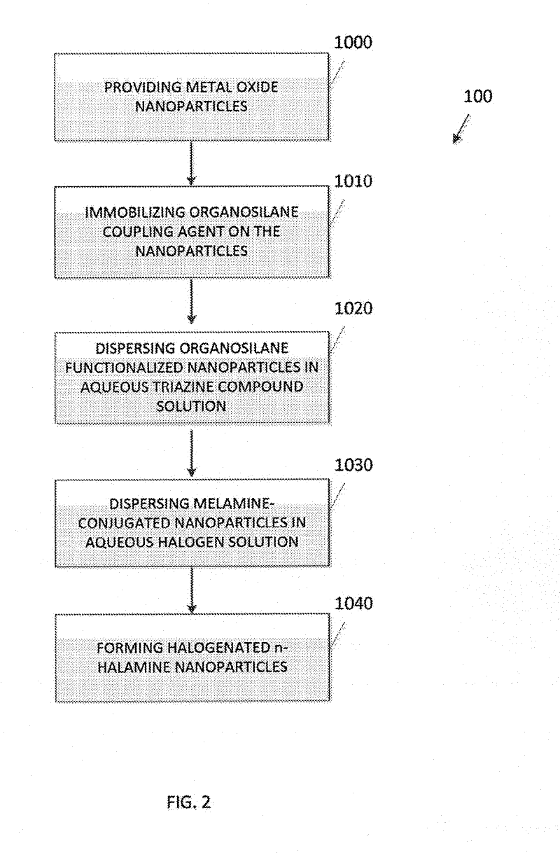

FIG. 2 is a flow chart illustrating a method 100 of preparing an antimicrobial powder according to at least some embodiments of the present disclosure. The method includes providing metal oxide nanoparticles as in 1000. In some embodiments, the metal oxide nanoparticles are hydrophilic, meaning the nanoparticles include active hydroxyl groups. In some embodiments, the metal oxide nanoparticles have a specific surface area of from about 30 m²/g to about 1,000 m²/g. In an example embodiment, the metal oxide nanoparticles have a specific surface area of about 200 m²/g. In at least some embodiments of the present disclosure, the metal oxide nanoparticles are at least one material chosen from silica (SiO₂) nanoparticles, titanium dioxide (TiO₂) nanoparticles, alumina (Al₂O₃) nanoparticles, chromium oxide (Cr₂O₃) nanoparticles, and mixtures thereof. In an example embodiment, the metal oxide nanoparticles are silica, or more specifically, hydrophilic fumed silica.

The method as shown in FIG. 2 further includes immobilizing an organosilane coupling agent on the metal oxide nanoparticles to form organosilane functionalized metal oxide nanoparticles as in 1010.

Method 100 further includes dispersing the organosilane functionalized metal oxide nanoparticles in an aqueous triazine compound solution to form triazine-conjugated metal oxide nanoparticles as in 1020. In at least some embodiments, the aqueous triazine compound solution includes triazine of the formula (I):

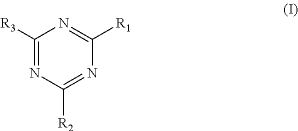

where R₁ is halogen, nitrogen, nitrogen halide, or organic group, R₂ is halogen, nitrogen, nitrogen halide, or organic group, and R₃ is halogen, nitrogen, nitrogen halide, or organic group. Suitable halogen groups for R₁, R₂, and/or R₂ include but are not limited to the following: chlorine (Cl), bromine (Br), and iodine (I). Suitable organic groups for R1, R2, and/or R3 include but are not limited to the following: carboxylates, hydroxyls, and epoxides. In a non-limiting example, the aqueous triazine compound solution is made by dissolving 0.021 mol triazine (melamine) per liter of water. The aqueous triazine compound solution pH is then adjusted to 7.4-8.0 using NaOH. The aqueous triazine compound solution is also referred to interchangeably herein as aqueous melamine solution. In some embodiments, the pH of the aqueous melamine solution is adjusted to pH 8.

The method further includes dispersing the melamine-conjugated metal oxide nanoparticles in an aqueous halogen solution as in 1030 to form as in 1040 halogenated N-halamine nanoparticles. A non-limiting example of halogenated N-halamine silica nanoparticles is shown in (III):

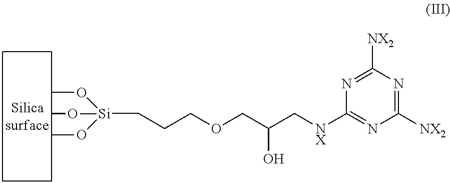

wherein at least one X is an element chosen from H, Cl, Br, and I. Formula (III) is a non-limiting example in which melamine is conjugated onto silica and X is hydrogen (H). The reaction takes place at room temperature with agitation over up to 12 hours. The solution concentration and pH for the aqueous halogen solution are same as for the aqueous triazine compound solution above (i.e. 0.021 mol per liter of water). The solution pH is then adjusted to 7.4-8.0 using NaOH.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

The experiments below were performed using the following materials, which were obtained, or are available, from various commercial suppliers:

hydrophilic fumed silica having a specific surface area of 200 m²/g;

(3-glycidyloxypropyl) trimethoxysilane (GOPTS);

1,3,5-Triazine-2,4,6-triamine (melamine);

sodium hypochlorite (12.5%);

sodium hydroxide pellets;

hydrochloric acid;

TRITON™ X-100, a non-wetting nonionic, octylphenol ethoxylate surfactant available from The Dow Chemical Company; and,

ethanol (reagent grade).

### Immobilization of GOPTS on Metal Oxide (Silica) Nanoparticles

Hydrophilic fumed silica (3.8 g) was dispersed into 195 mL ethanol followed by the addition of 1.425 mL GOPTS. The mixture was then agitated for 24 hours using a magnetic stirring system. Next, the mixture was centrifuged, and excess ethanol decanted to form GOPTS-modified silica.

To remove unreacted compounds and excess ethanol, the GOPTS-modified silica was washed with water having a pH of 8. The wash was prepared by adjusting the pH of 200 mL of water with sodium hydroxide. Half of the wash solution was added to the GOPTS-modified silica. The mixture was shaken for 5 minutes, then centrifuged and decanted. This process was repeated with the remaining water for a second wash step.

Target particle size of the GOPTS functionalized nanoparticles was 100 nm or less.

### Synthesis of Melamine-Conjugated Silica Nanoparticles

Following the wash, the GOPTS-modified silica was dispersed in 380 mL of aqueous melamine solution with pH adjusted to pH 8 and shaken for 24 hours to produce melamine-functionalized silica. The aqueous triazine compound solution was made by dissolving 0.021 mol triazine per liter of water. The solution pH was then adjusted to 8 using NaOH. The melamine-functionalized silica was then centrifuged and washed with deionized water twice. The end product was dried under vacuum to constant weight, then reconstituted into powder by grinding to form a melamine-conjugate silica powder.

### Halogenation of N-Halamine Nanoparticles

Chlorination of melamine/silica nanoparticles was carried out by dispersing 1 g of the dried melamine-conjugate silica powder into a 200 mL aqueous solution containing 5% (w/w) sodium hypochlorite plus 0.05% Triton X-100, then adjusted to pH 7 using HCl. The mixture was vigorously stirred for 2 hours, then washed twice with deionized water, dried under vacuum, and finally reconstituted into powder by grinding. The reaction procedure is illustrated in FIG. 1.

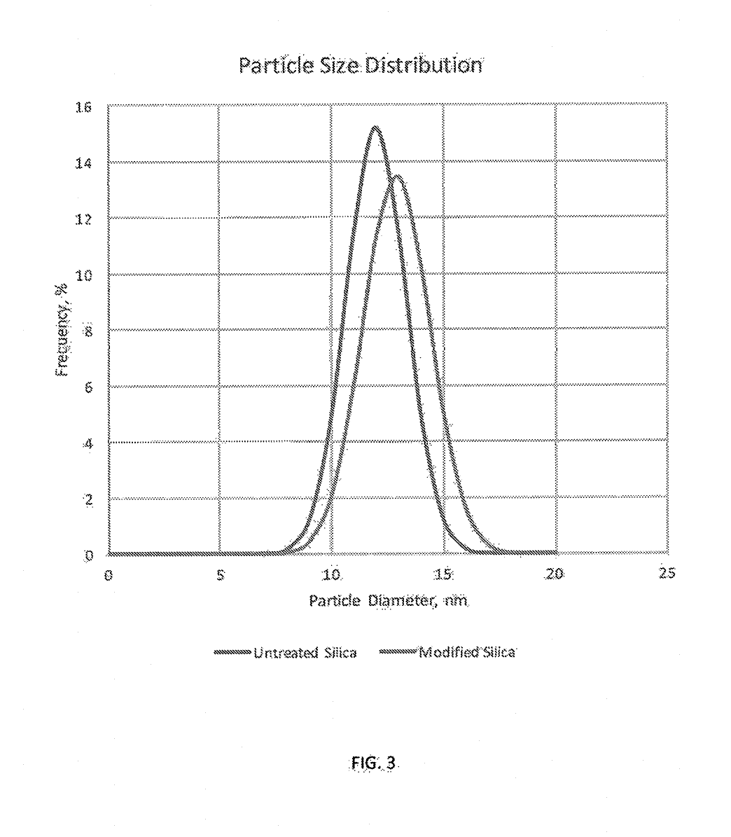

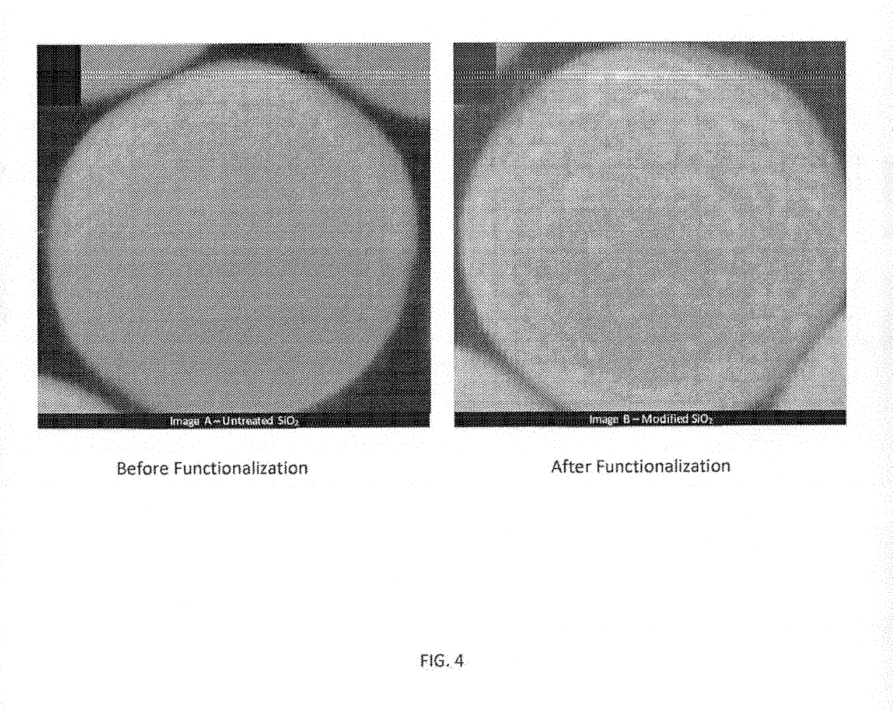

Particle size distribution and scanning electron microscope images, as shown in FIGS. 3 and 4, were collected to assess the particle morphology before and after functionalization, in other words according to method 100 of FIG. 2, before and after step 1010 of immobilizing the organosiliane coupling agent on the nanoparticles. As shown in FIG. 3, the particle size distribution for a sample using silica nanoparticles remained between 10 and 15 nm upon functionalization, the average particle diameter of functionalized/immobilized nanoparticles having increased slightly. Particle morphology is shown in FIG. 4 by SEM micrographs before (on left) and after (on right) functionalization/immobilization.

To determine the active chlorine contents, final dried powder samples (0.05 g) were dispersed in 20 mL of equal parts ethanol and DI water containing 1% (w/w) acetic acid and 0.05% (w/w) Triton X-100. One gram of potassium iodide was added, and the mixture was stirred for 1 hour at room temperature under N2 atmosphere. The released iodine was titrated with 0.01 mol/L sodium thiosulfate aqueous solution. Blank titrations were performed under the same conditions to serve as controls. Percentage of chlorine content was calculated according to the Equation IV:

$$Cl \% = \frac{35.5}{2} \frac{( {V}_{Cl} - {V}_{0} ) \times {10}^{- 3} \times 0.01}{{W}_{Cl}} \times 100$$

where V_{cl} and V₀ were the volumes (mL) of sodium thiosulfate solutions consumed in the titration of the polymeric N-halamine film and the control, respectively, and W_{cl} (g) was the weight of the dry film. Each test was repeated three times, and the average active chlorine content recorded was 0.37%.

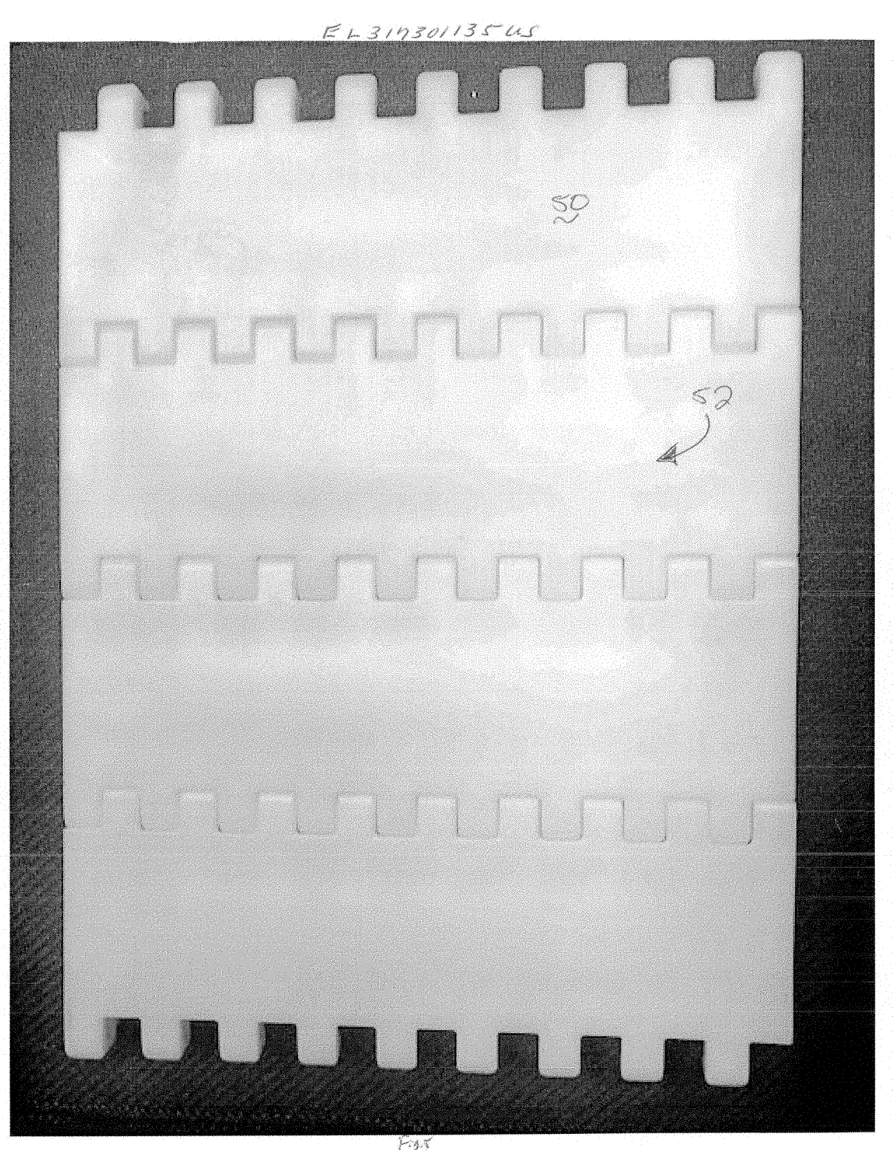

Antimicrobial tests were performed by incorporating the unhalogenated and halogenated (i.e., unchlorinated and chlorinated) nanoparticles prepared above into a polymeric material. The polymeric material such as polyethglene is selected for its properties as a substitute for purposes of conveyor belting or other components used in an environment, such as food processing, where it is desirable to reduce bacteria, microbs, and other hazards. Thus, substantially the entire upper surface of a conveyor belt would be made of a material, preferably a polymer, which includes the antimicrobid powder. Referring to FIG. 5, a conveyor belt having multiple sections 52, is made from a polymeric material including the antimicrobid powder. Thus, substantially all of its upper surface 50, which would come in contact with conveyed product, such as a consumable, will exhibit antimicrobid properties. The tests were performed in a Biosafety Level 2 hood. The guidelines provided by the U.S. Department of Health and Human Services, as referenced in Richmond, J. Y.; McKinney, R. W. Biosafety in Microbiological and Biomedical Laboratories, 4th ed.; U.S. Government Printing Office: Washington, D C, 1999, were followed and appropriate protective equipment including gowns and gloves and recommended decontamination protocols were used to ensure lab safety. In the antibacterial study, Listeria monocytogenes (L. monocytogenes, ATCC 19115) and Escherichia coli (E. coli, ATCC 15597) were used as example non-resistant Gram-positive and Gram-negative bacteria, respectively. To prepare the bacteria or yeast suspensions, L. monocytogenes 19115, E. coli 15597, were grown in appropriate broth solutions at 37° C. for 24 hours. Cells were harvested by centrifuge, washed twice with sterile phosphate buffered saline (PBS), and then re-suspended in sterile PBS to 108-109 CFU/mL. Bacterial suspensions (50 μL) were added into sample suspension (450 μL), mixed well, and incubated under constant shaking. After a certain period of contact time, 0.03 wt % sodium thiosulfate aqueous solution (4.5 mL) was added into the reaction suspension to neutralize the active chlorine and stop the antibacterial action of the sample. The resulting mixture was mixed well, serially diluted, and then 100 μL of each dilution was dispersed onto LB agar plates. Colonies on the plates were counted after incubation at 37° C. for 24 hours to calculate antimicrobial efficacy. Antimicrobial Efficacy results are listed in Table 1 in which the polymeric material without nanoparticles is labeled “unmodified control,” the polymeric material with unchlorinated nanoparticles is labeled “modified but unchlorinated,” and the polymeric material with chlorinated nanoparticles is labeled “modified and chlorinated.”

TABLE 1
Antimicrobial Efficacy

| | Unmodified | Modified but | Modified and |
|---|---|---|---|
| | Control | Unchlorinated | Chlorinated |
| L. monocytogenes | 5% | 0% | 99.40% |
| E. coli | 4% | 17% | 99.90% |

As reported in Table 1, significant improvement in antimicrobial efficacy was seen in the sample containing the chlorinated nanoparticles.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. An antimicrobial powder comprising:
metal oxide nanoparticles;
an organosilane coupling agent immobilized on the nanoparticles; and
triazine-based N-halamine compounds having functional groups covalently bonded to the organosilane coupling agent.

2. The antimicrobial powder of claim 1, wherein the metal oxide nanoparticles are hydrophilic.

3. The antimicrobial powder of claim 1, wherein the metal oxide nanoparticles have a specific surface area of from about 30 m²/g to about 1,000 m²/g.

4. The antimicrobial powder of claim 3, wherein the metal oxide nanoparticles have a specific surface area of about 200 m²/g.

5. The antimicrobial powder of claim 1, wherein the metal oxide nanoparticles are at least one material chosen from silica (SiO₂) nanoparticles, titanium dioxide (TiO₂) nanoparticles, alumina (Al₂O₃) nanoparticles, chromium oxide (Cr₂O₃) nanoparticles, and mixtures thereof.

6. The antimicrobial powder of claim 5, wherein the metal oxide nanoparticles are silica nanoparticles.

7. The antimicrobial powder of claim 6, wherein the metal oxide nanoparticles are hydrophilic fumed silica nanoparticles.

8. The antimicrobial powder of claim 1, wherein the metal oxide nanoparticles have an equivalent spherical diameter of from about 5 nm to about 1,000 nm.

9. The antimicrobial powder of claim 1, wherein the organosilane coupling agent is at least one member chosen from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, (3-Glycidoxypropyl)methyldiethoxysilane, and mixtures thereof.

10. The antimicrobial powder of claim 9, wherein the organosilane coupling agent is (3-Glycidyloxypropyl)trimethoxysilane (GOPTS).

11. The antimicrobial powder of claim 1, wherein the triazine-based N-halamine compounds include triazine of the formula (I): 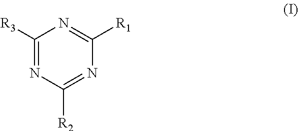
where R₁ is halogen, nitrogen, nitrogen halide, or organic group;
R₂ is halogen, nitrogen, nitrogen halide, or organic group; and,
R₃ is halogen, nitrogen, nitrogen halide, or organic group;
wherein halogen is chosen from chlorine (Cl), bromine (Br), iodine (I), and mixtures thereof; and wherein organic group is chosen from carboxylates, hydroxyls, epoxides, and mixtures thereof.

12. The antimicrobial powder of claim 1, wherein the triazine-based N-halamine compounds include the replacement of one or more hydrogens with at least one member chosen from Cl, Br, and I.

13. A method of preparing an antimicrobial powder, the method comprising:
providing metal oxide nanoparticles;
immobilizing an organosilane coupling agent on the metal oxide nanoparticles to form organosilane functionalized metal oxide nanoparticles;
dispersing the organosilane functionalized metal oxide nanoparticles in an aqueous triazine compound solution to form triazine-conjugated metal oxide nanoparticles,
wherein the aqueous triazine compound solution includes triazine of the formula (I): 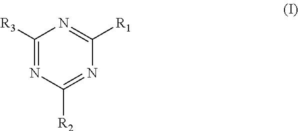
where R1 is halogen, nitrogen, nitrogen halide, or organic group;
R2 is halogen, nitrogen, nitrogen halide or organic group; and,
R3 is halogen, nitrogen, nitrogen halide or organic group;
wherein halogen is chosen from chlorine (Cl), bromine (Br), iodine (I), and mixtures thereof; and wherein organic group is chosen from carboxylates, hydroxyls, epoxides, and mixtures thereof;
dispersing the triazine-conjugated metal oxide nanoparticles in an aqueous halogen solution to form halogenated N-halamine nanoparticles.

14. The method of claim 13, wherein the metal oxide nanoparticles are hydrophilic.

15. The method of claim 13, wherein the metal oxide nanoparticles have a specific surface area of from about 30 m²/g to about 1,000 m²/g.

16. The method of claim 15, wherein the metal oxide nanoparticles have a specific surface area of about 200 m²/g.

17. The method of claim 13, wherein the metal oxide nanoparticles are at least one material chosen from silica (SiO₂) nanoparticles, titanium dioxide (TiO₂) nanoparticles, alumina (Al₂O₃) nanoparticles, chromium oxide (Cr₂O₃) nanoparticles, and mixtures thereof.

18. The method of claim 17, wherein the metal oxide nanoparticles are silica nanoparticles.

19. The method of claim 18, wherein the metal oxide nanoparticles are hydrophilic fumed silica nanoparticles.

20. The method of claim 13, wherein the metal oxide nanoparticles have an equivalent spherical diameter of from about 5 nm to about 1,000 nm.

21. The method of claim 13, wherein the organosilane coupling agent is at least one member chosen from Aminopropyltriethoxysilane (APTES), (3-Acryloxypropyl)trimethoxysilane, Methacryloxypropyltrimethoxysilane, 3-Aminopropyltriethoxysilane, 3-Aminopropyltrimethoxisilane, 3-Aminopropylmethyldiethoxysilane, (3-Glycidyloxypropyl)trimethoxysilane (GOPTS), (3-Glycidoxypropyl)trimethoxysilane, (3-Glycidoxypropyl)methyldiethoxysilane, and mixtures thereof.

22. The method of claim 21, wherein the organosilane coupling agent is (3-Glycidyloxypropyl)trimethoxysilane (GOPTS).

23. The method of claim 22, wherein immobilizing the metal oxide nanoparticles includes dispersing the metal oxide nanoparticles in ethanol followed by the addition of GOPTS to form GOPTS functionalized metal oxide nanoparticles.

24. The method of claim 13, wherein the aqueous melamine solution has a pH of 8.

25. The method of claim 13, wherein the aqueous halogen solution is hypochlorite.

26. A polymeric material including an antimicrobial powder comprising:
metal oxide nanoparticles;
an organosilane coupling agent immobilized on the nanoparticles; and
triazine-based N-halamine compounds having functional groups covalently bonded to the organosilane coupling agent.

27. The polymeric material of claim 26 where in the polymeric material is adopted for use as a conveyor belt component.

28. A conveyor belt material including an antimicrobial powder comprising:
metal oxide nanoparticles;
an organosilane coupling agent immobilized on the nanoparticles; and
triazine-based N-halamine compounds having functional groups covalently bonded to the organosilane coupling agent.
